(19) United States
(12) Patent Application Publication
(10) Pub. No.: US 2015/0328949 A1
(43) Pub. Date: Nov. 19, 2015

(54) AIR SUSPENSION CONTROL SYSTEMS AND METHODS FOR A VEHICLE

(71) Applicant: GM GLOBAL TECHNOLOGY OPERATIONS LLC, Detroit, MI (US)

(72) Inventors: CHRISTOPHER M. FRIZZA, BEVERLY HILLS, MI (US); JACEK MARCHEL, ROCHESTER HILLS, MI (US)

(73) Assignee: GM GLOBAL TECHNOLOGY OPERATIONS LLC, Detroit, MI (US)

(21) Appl. No.: 14/280,401

(22) Filed: May 16, 2014

(51) Int. Cl. B60G 17/015; B60G 17/052

(52) U.S. Cl. CPC B60G 17/0155; B60G 17/0525; B60G 2202/152; B60G 2400/25; B60G 2400/60; B60G 2500/30; B60G 2500/202

(57) ABSTRACT

Methods and systems are provided for controlling a suspension system having an air spring. In one embodiment, a method includes: determining a desired value associated with a height of the air spring; determining an operating value associated with a height of the air spring; and controlling an amount of air at least one of to and from the air spring based on a comparison of the desired value and the operating value.

### TECHNICAL FIELD

The present disclosure generally relates to suspension systems and methods of a vehicle, and more particularly to control systems and methods for air suspension systems of a vehicle.

### BACKGROUND

Vehicle suspension systems are configured so that the wheels are able to follow elevation changes in the road surface as the vehicle travels therealong. When a rise in the road surface is encountered, the suspension responds in “jounce” in which the wheel is able to move upwardly relative to the frame of the vehicle. On the other hand, when a dip in the road surface is encountered, the suspension responds in “rebound” in which the wheel is able to move downwardly relative to the frame of the vehicle.

In either jounce or rebound, a spring is incorporated at the wheel in order to provide a resilient response to the respective vertical movements with regard to the vehicle frame. The spring may be, for example, an air spring. Air springs are typically powered by an engine driven or electric air pump or compressor. This pump or compressor compresses the air, provides the compressed air to a spring chamber, and the compressed air is used as a spring.

A height (trim) of the vehicle chassis may be adjusted using the air spring. For example, a control module may generate control signals to control the amount of compressed air in the air spring. A height of the air spring is adjusted based on the amount of air in the spring. The adjusted height of the air spring adjusts the height of the vehicle chassis. The air spring may be adjusted to a maximum height. The air spring may only be operated at the maximum height under certain low load conditions.

Accordingly, it is desirable to provide control methods and systems for adjusting the height of the air spring. Furthermore, other desirable features and characteristics of the present disclosure will become apparent from the subsequent detailed description and the appended claims, taken in conjunction with the accompanying drawings and the foregoing technical field and background.

### SUMMARY

Methods and systems are provided for controlling a suspension system having an air spring. In one embodiment, a method includes: determining a desired value associated with a height of the air spring; determining an operating value associated with a height of the air spring; and controlling an amount of air at least one of to and from the air spring based on a comparison of the desired value and the operating value.

In another embodiment, a system includes: an air spring; an air reservoir coupled to the air spring; a first control valve disposed between the air reservoir and the air spring; and a control module that evaluates a load on the air spring and that controls the first control valve to adjust a value associated with a height of the air spring based on the load.

### DESCRIPTION OF THE DRAWINGS

The present disclosure will hereinafter be described in conjunction with the following drawing figures, wherein like numerals denote like elements, and:

FIG. 1 is a functional block diagram illustrating a vehicle that includes an air suspension system in accordance with various embodiments;

FIG. 2 is a dataflow diagram illustrating a control system of the air suspension system in accordance with various exemplary embodiments;

FIG. 3 is a graph illustrating an operating height of an air spring relative to a load on the air spring; and

FIG. 4 is a flowchart illustrating control methods of the air suspension system in accordance with exemplary embodiments.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

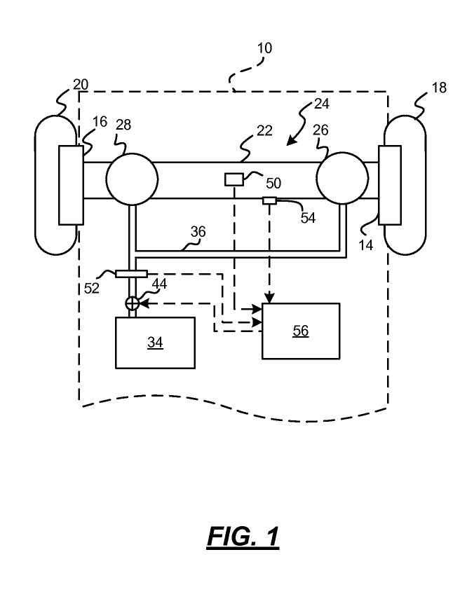

Referring now to FIG. 1, a vehicle 10 is shown having an air suspension system in accordance with various embodiments. Although the figures shown herein depict an example with certain arrangements of elements, additional intervening elements, devices, features, or components may be present in an actual embodiment. It should also be understood that FIG. 1 is merely illustrative and may not be drawn to scale.

The vehicle 10 is shown to include wheels 14, 16, each fitted with a tire 18, 20 respectively. The wheels 14, 16 are supported by a vehicle frame 22 via an air suspension system shown generally at 24. The air suspension system 24 generally includes air springs 26, 28. Although the air suspension system 24 is shown to be associated with only two wheels 14, 16 for ease of description (e.g., either front wheels or rear wheels), it is appreciated that the air suspension system 24 of the present disclosure is also applicable to a single wheel 14 or all wheels 14, 16 (plus others not shown) of the vehicle 10.

The air springs 26, 28 store air and are configured to displace under load at a variable rate. An air compressor 34 having an air reservoir supplies air to the air springs 26, 28 via one or more conduits 36. A first valve 44, for example a solenoid valve, is selectively controlled to a first position to replenish the air in the air springs 26, 28 with air from the air compressor 34. The first valve 44 is selectively controlled to a second position to release the air in the air springs 26, 28 to the atmosphere or back to the compressor 34. As can be appreciated, in various embodiments, the air suspension system 24 may include additional valves 44, for example, one for each air spring 26, 28, and/or separate valves one for the replenishment of air and one for the release of air. For exemplary purposes, the disclosure will be discussed in the context of a single valve 44.

The vehicle 10 further includes various sensors that detect and measure observable conditions of the air suspension system 24 and/or the vehicle 10. The sensors generate sensor signals based on the observable conditions. In one example, a height sensor 50 detects a height of the air springs 26, 28 and generates height signals based thereon. For example, the height may be measured based on a measurement (e.g., taken optically, mechanically, or a combination thereof) of a part of the suspension system 24 (e.g., a link, a control arm, or similar part (not shown)) relative to a fixed point on the body or frame 22. As can be appreciated, a single height sensor 50 may be implemented for all of the air springs 26, 28 (as shown) or, may be implemented for each air spring 26, 28.

In another example, a pressure sensor 52 detects the air pressure within the air springs 26, 28 and generates pressure signals based thereon. As can be appreciated, a single pressure sensor 52 may be implemented for all of the air springs 26, 28 (as shown) or, may be implemented for each air spring 26, 28. In yet another example, a load sensor 54 detects the load on the suspension system 24 and generates load signals based thereon.

A control module 56 controls the first valve 44 based on one or more of the sensor signals and further based on the suspension control systems and methods of the present disclosure. Generally speaking, the suspension control systems and methods adjust the height of the air springs 26, 28 to adjust the trim of the vehicle 10. The suspension control systems and methods adjust the height of the air springs 26, 28 based on an acceptable operating height of the air spring 26, 28. The acceptable operating height of the air spring 26, 28 may be based on a load on the suspension system 24. The load may be determined from the load sensor 54 and/or the pressure sensor 52.

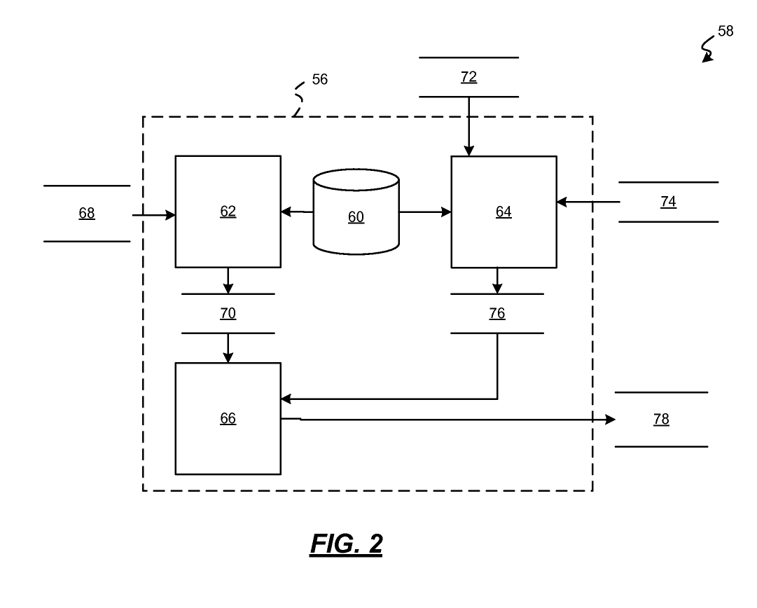

Referring now to FIG. 2 and with continued reference to FIG. 1, a dataflow diagram illustrates various embodiments of a suspension control system 58 for the air suspension system 24 that may be embedded within the control module 56. Various embodiments of suspension control systems 58 according to the present disclosure may include any number of sub-modules embedded within the control module 56. As can be appreciated, the sub-modules shown in FIG. 2 may be combined and/or further partitioned to similarly control the height of the air springs 26, 28 thereby controlling a trim of the vehicle 10. Inputs to the system 58 may be sensed from the vehicle 10, received from other control modules (not shown), and/or determined/modeled by other sub-modules (not shown) within the control module 56. In various embodiments, the control module 56 includes a height data datastore 60, a desired height determination module 62, an operating height determination module 64, and a valve control module 66.

The desired height determination module 62 receives as input a desired trim mode 68. The desired trim mode 68 may be, for example, determined based on vehicle conditions or may be user selectable using a switch or other device used for indicating a desired trim mode. In one example, the desired trim mode 68 may be a default mode (e.g., a mode associated with a standard trim height of the vehicle 10), an off-road trim mode (e.g., a mode associated with an increased trim height of the vehicle 10 to accommodate obstacles), or an aero trim mode (e.g., a mode associated with a reduced trim height of the vehicle 10 to improve the aerodynamic efficiency of the vehicle 10).

Based on the desired trim mode 68, the desired height determination module 62 determines a desired height 70 of the air springs 26, 28. For example, when the desired trim mode 68 is the default mode, the desired height determination module 62 sets the desired height 70 to a default height. In various embodiments, the default height may be a predefined default height stored in the height data datastore 60. In another example, when the desired trim mode 68 is the off road trim mode, the height determination module 62 sets the desired height 70 to an off-road height that is higher than the default height. The off road height may be a predefined height stored in the height data datastore 60. In still another example, when the desired trim mode 68 is the aero trim mode, the height determination module 62 sets the desired height 70 to an aero height that is lower than the default height. The aero height may be a predefined height stored in the height data datastore 60.

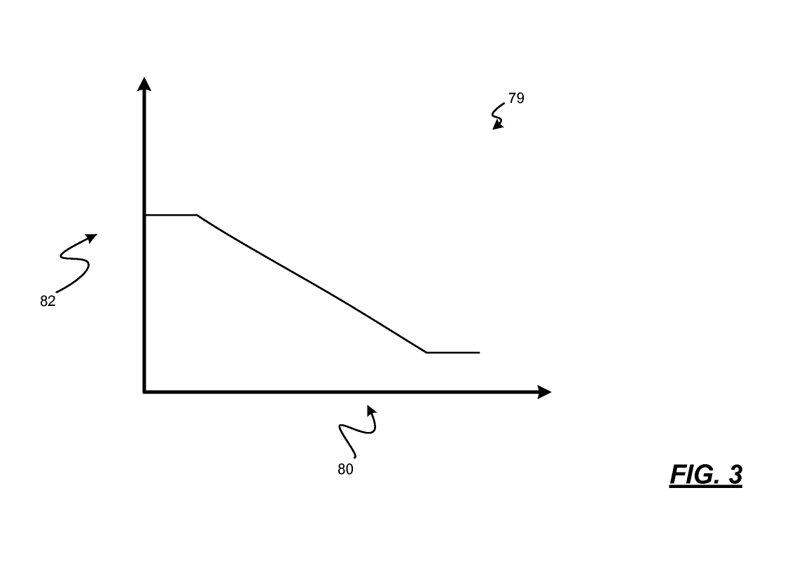

The operating height determination module 64 receives as input load data 72, and optionally height data 74. The load data 72 indicates a load on the suspension system 24. In various embodiments, the load data 72 may be received or determined from the load sensor 54 and/or the pressure sensor 52. The height data 74 indicates a current height of the air springs 26, 28. Based on the load data 72 and/or the height data 74, the operating height determination module 64 determines an acceptable operating height 76 of the air springs 26, 28. In one example, as shown in FIG. 3, the acceptable operating height 76 may be based on a load based curve 79 (including straight line or a line having various curvatures) that may be associated with a particular type of air spring. Various points of the load based curve 70 may be stored in the height data datastore 60. As shown, the x-axis 80 represents the load and the y-axis 82 represents the acceptable operating height. The exemplary curve 70 illustrates that as the load increases, the acceptable operating height decreases.

With reference back to FIG. 2, the valve control module 66 receives as input the desired height 70 and the operating height 76. Based on the desired height 70 and the operating height 76, the valve control module 66 generates control signals 78 to control the control valve 44. For example, the valve control module 66 compares the desired height 70 to the operating height 76. If the desired height 70 is greater than the operating height 76, the valve control module 66 determines an air value based on the operating height 76 and generates a control signal 78 based on the air value. If, however, the desired height 70 is less than or equal to the operating height 76, the valve control module 66 determines an air value based on the desired height 70, and generates a control signal 78 based on the air value. In various embodiments, the air value corresponds to an amount of air that needs to be supplied to or removed from the air springs 26, 28, in order to achieve the height (either the desired height 70 or the operating height 76) given the current height.

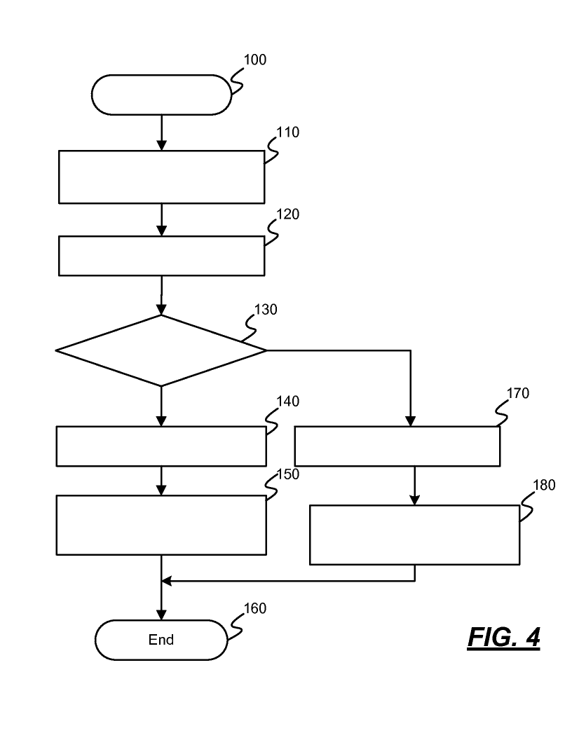

Referring now to FIG. 4 and with continued reference to FIGS. 1 and 2, a flowchart illustrates a control method that can be performed by the control module 56 in accordance with the present disclosure. As can be appreciated in light of the disclosure, the order of operation within the method is not limited to the sequential execution as illustrated in FIG. 4, but may be performed in one or more varying orders as applicable and in accordance with the present disclosure.

In various embodiments, the method can be scheduled to run based on predetermined events, and/or can run continually during operation of the vehicle 10.

In one example, the method may begin at 100. The desired height 70 is determined based on the desired trim mode 68 at 110. The operating height is determined based on the load 72 and/or the height 74 at 120. The desired height 70 is compared with the operating height 76 at 130. If the desired height 70 is greater than the operating height 76 at 130, the air value to reach the operating height 76 is determined at 140 and control signals 78 are generated based on the air value to control the control valve 44 such that the operating height 76 is achieved at 150. Thereafter, the method may end at 160.

If, however, the desired height 70 is less than or equal to the operating height 76 at 130, the air value to reach the desired height 70 is determined at 170 and control signals 78 are generated based on the air value to control the control valve 44 such that the desired height 70 is achieved at 180. Thereafter, the method may end at 160.

While exemplary embodiments were discussed in the context of the desired height 70 and the operating height 76 of the air springs 26, 28, it is appreciated that alternative exemplary embodiments can evaluate a compression of the air springs or any other height related attributes of the air springs in order to determine the air value and the control signals for controlling the valve 44 an acceptable compression or other height related attribute.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of controlling a suspension system having an air spring, comprising:
determining a desired value associated with a height of the air spring;
determining an operating value associated with a height of the air spring; and
controlling an amount of air at least one of to and from the air spring based on a comparison of the desired value and the operating value.

2. The method of claim 1, wherein the determining the desired value is based on a desired trim mode.

3. The method of claim 2, wherein the desired trim mode is at least one of a default mode, an off road mode, and an aero mode.

4. The method of claim 1, wherein the determining the operating value is based on a load on the suspension system.

5. The method of claim 4, wherein the load on the suspension system is indicated by a load signal from a load sensor of the suspension system.

6. The method of claim 4, wherein the load on the suspension system is indicated by a pressure signal from a pressure sensor of the air spring.

7. The method of claim 1, wherein the operating value is based on a current height of the air spring.

8. The method of claim 4, wherein the determining the operating value is based on a load based curve.

9. The method of claim 1, further comprising comparing the operating value with the desired value, and wherein the comparison is based on the comparing.

10. The method of claim 9, wherein the controlling comprises controlling an amount of air based on the desired value when the desired value is less than or equal to the operating value.

11. The method of 9, wherein the controlling comprises controlling an amount of air based on the operating value when the desired value is greater than the operating value.

12. A suspension system, comprising:
an air spring;
an air reservoir coupled to the air spring;
a first control valve disposed between the air reservoir and the air spring; and
a control module that evaluates a load on the air spring and that controls the first control valve to adjust a value associated with a height of the air spring based on the load.

13. The suspension system of claim 12, wherein the control module determines a desired value associated with the height of the air spring, determines an operating value associated with the height of the air spring based on the load; and controls the valve based on an amount of air that is determined based on at least one of the desired value and the operating value.

14. The suspension system of claim 13, wherein the control module determines the desired value based on a desired trim mode.

15. The suspension system of claim 12, wherein the load on the air spring is indicated by a load signal from a load sensor of the suspension system.

16. The suspension system of claim 12, wherein the load on the air spring is indicated by a pressure signal from a pressure sensor of the air spring.

17. The suspension system of claim 13, wherein the control module determines the operating value based on a current height of the air spring.

18. The suspension system of claim 13, wherein the control module determines the operating value based on a load based curve.

19. The suspension system of claim 13, wherein the control module compares the operating value with the desired value, and determines the amount of air based on the comparison.

20. The suspension system of claim 19, wherein the control module determines the amount of air based on the desired value when the desired value is less than or equal to the operating value.

21. The suspension system of claim 19, wherein the control module determines the amount of air based on the operating value when the desired value is greater than the operating value.
